(19) United States
(12) Patent Application Publication
(10) Pub. No.: US 2025/0037382 A1
(43) Pub. Date: Jan. 30, 2025

(54) Augmented Reality System For Locating A Parked Vehicle And Navigating Thereto

(71) Applicant: Mercedes-Benz Group AG, Stuttgart (DE)

(72) Inventors: Kavita Saney, Fremont, CA (US); Kevin Gee, Union City, CA (US)

(21) Appl. No.: 18/360,516

(22) Filed: Jul. 27, 2023

(51) Int. Cl. G06T 19/00; G01C 21/34; G01C 21/36

(52) U.S. Cl. CPC G06T 19/003; G01C 21/3407; G01C 21/3626; G06T 19/006; G06T 2200/24

(57) ABSTRACT

Methods, computing systems, and technology for locating and navigating to a parked vehicle is presented. For example, a computing system may be configured to access data indicative of a location of a vehicle associated with a user. The computing system may be configured to determine a user interface element for display associated with the vehicle within an augmented reality environment. The computing system may be configured to output one or more signals to present, via a display device associated with a user device, content that presents the user interface element associated with the vehicle within the augmented reality environment. The user interface element may be visible within the augmented reality environment at the location of the vehicle when at least a portion of the vehicle is within a field of view of the user.

### FIELD

The present disclosure relates generally to locating a parked vehicle using augmented reality. More particularly, the present disclosure relates to generating navigational data and/or augmented reality graphics for locating a parked vehicle and navigating to its parked location.

### BACKGROUND

A parked vehicle may, at first glance or after an extended period of time, be difficult to locate from a given location. Further, even if the general location of the vehicle is known, identifying it may be difficult given the surrounding environment or other parked cars.

### SUMMARY

Aspects and advantages of implementations of the present disclosure will be set forth in part in the following description, or may be learned from the description, or may be learned through practice of the implementations.

One example aspect of the present disclosure is directed to a computer-implemented method. The computer-implemented method includes accessing, by a computing system, data indicative of a location of a vehicle associated with a user. The computer-implemented method includes determining, by the computing system, a user interface element for display associated with the vehicle within an augmented reality environment. The computer-implemented method includes outputting, by the computing system, one or more signals to present, via a display device associated with a user device, content that presents the user interface element associated with the vehicle within the augmented reality environment, wherein the user interface element is visible within the augmented reality environment at the location of the vehicle when at least a portion of the vehicle is within a field of view of the user.

In an embodiment the display device is a display device of a wearable computing system, and the method includes accessing, by the computing system, data indicative of a location of the user device, wherein the user device is associated with the user. In an embodiment the display device is a display device of a wearable computing system, and the method includes determining, by the computing system and based on the data indicative of the location of the vehicle and the location of the user device, a route to the location of the vehicle. In an embodiment the display device is a display device of a wearable computing system, and the method includes generating, by the computing system and based on the route to the location of the vehicle, navigation content comprising information for navigating the user to the location of the vehicle. In an embodiment the display device is a display device of a wearable computing system, and the method includes outputting, by the computing system, one or more signals to display, via a user interface of the wearable computing system, the navigation content for the user within the augmented reality environment, the navigation content including the information for navigating the user to the location of the vehicle.

In an embodiment determining the route to the location of the vehicle includes determining, by the computing system and based on the location of the vehicle and the location of the user device, a relative location of the vehicle to the user device. In an embodiment determining the route to the location of the vehicle includes determining, by the computing system, the route to the location of the vehicle based on the relative location of the vehicle to the user device.

In an embodiment, determining the user interface element for display associated with the vehicle within the augmented reality environment includes generating a first set of augmented reality graphics based on the field of view of the user and the location of the user. In an embodiment, determining the user interface element for display associated with the vehicle within the augmented reality environment includes generating a second set of augmented reality graphics based on the navigation content and the route to the location of the vehicle.

In an embodiment, the second set of augmented reality graphics includes directional steps for moving from the location of the user device to the location of the vehicle based on the navigation content. In an embodiment, the second set of augmented reality graphics includes a pathway, based on the route to the location of the vehicle, indicative of where to move to arrive at the vehicle.

In an embodiment, the user device is a wearable computing system, and the display device is an augmented reality display of the wearable computing system.

In an embodiment, the vehicle is a personal vehicle of the user.

In an embodiment, the vehicle is associated with a transportation service for the user, and the data indicative of the location of the vehicle is provided via a computing system associated with the transportation service.

In an embodiment, the data indicative of the location of the vehicle is provided by the vehicle when the vehicle is in a parked state.

In an embodiment, the computing system is a remote computing system that is remote from the user device and the vehicle.

In an embodiment, accessing data indicative of the location of the vehicle includes outputting one or more signals to wake-up the vehicle. In an embodiment, accessing data indicative of the location of the vehicle includes, in response to the one or more signals to wake-up the vehicle, receiving, from the vehicle, the data indicative of the location of the vehicle.

In an embodiment, the computing system is a computing system of the user device.

In an embodiment, the computer-implemented method includes determining, by the computing system, that the user device is within a communication range of the vehicle.

In an embodiment, the user interface element includes an icon positioned above the location of the vehicle.

One example aspect of the present disclosure is directed to a computing system of a vehicle. The computing system includes a control circuit configured to access data indicative of a location of a vehicle associated with a user. The control circuit is configured to determine a user interface element for display associated with the vehicle within an augmented reality environment. The control circuit is configured to output one or more signals to present, via a display device associated with a user device, content that includes the user interface element associated with the vehicle within the augmented reality environment, wherein the user interface element is visible within the augmented reality environment at the location of the vehicle when at least a portion of the vehicle is within a field of view of the user.

In an embodiment, the display device is a display device of a wearable computing system, and the control circuit is further configured to access data indicative of a location of the user device, wherein the user device is associated with the user. In an embodiment, the display device is a display device of a wearable computing system, and the control circuit is further configured to determine, based on the data indicative of the location of the vehicle associated with the user and the location of the user device, a route to the location of the vehicle. In an embodiment, the display device is a display device of a wearable computing system, and the control circuit is further configured to generate, based on the route to the location of the vehicle, navigation content comprising information for navigating the user to the location of the vehicle. In an embodiment, the display device is a display device of a wearable computing system, and the control circuit is further configured to output one or more signals to display, via a user interface of the wearable computing system, the navigation content for the user within the augmented reality environment, the navigation content including the information for navigating the user to the location of the vehicle.

In an embodiment, determining the user interface element for display associated with the vehicle within the augmented reality environment includes generating a first set of augmented reality graphics based on the navigation content and the route to the location of the vehicle. In an embodiment, determining the user interface element for display associated with the vehicle within the augmented reality environment includes generating a second set of augmented reality graphics based on the field of view of the user and the location of the user.

In an embodiment, the user device is a head-wearable computing system, and the display device is an augmented reality display of the head-wearable computing system.

In an embodiment, the vehicle is a personal vehicle of the user or a vehicle being utilized for providing a transportation service requested by the user via a software application associated with the transportation service, the software application running on the user device.

One example aspect of the present disclosure is directed to one or more non-transitory computer-readable media that store instructions that are executable by a control circuit to: access data indicative of a location of the user device, wherein the user device is associated with the user; determine, based on the data indicative of the location of the vehicle and the location of the user device, a route to the location of the vehicle; generate, based on the route to the location of the vehicle, navigation content comprising information for navigating the user to the location of the vehicle; and output one or more signals to display, via a user interface of the wearable computing system, the navigation content for the user within the augmented reality environment, the navigation content comprising the information for navigating the user to the location of the vehicle.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIG. 2 illustrates an example computing system according to an embodiment hereof.

FIG. 3 illustrates an example augmented reality computing data flow according to an embodiment hereof.

FIG. 4 illustrates an example parked vehicle according to an embodiment hereof.

FIG. 5 illustrates an example augmented reality display according to an embodiment hereof.

FIG. 6 illustrates an example augmented reality device according to an embodiment hereof.

FIG. 7 illustrates an example augmented reality environment according to an embodiment hereof.

FIG. 8 illustrates an example augmented reality display according to an embodiment hereof.

FIG. 9 illustrates example navigation data according to an embodiment hereof.

FIG. 10 illustrates an example augmented reality device according to an embodiment hereof.

FIG. 11 illustrates a flowchart diagram of an example method according to an embodiment hereof.

FIG. 12 illustrates a block diagram of an example computing system according to an embodiment hereof.

### DETAILED DESCRIPTION

Example aspects of the present disclosure relate to systems and methods for locating parked vehicles. For instance, a vehicle may be parked in a large parking area and completely obscured from view when looking at it from within the parking area. In addition, the time and circumstances between parking a vehicle and returning to the parking area may result in a user associated with the vehicle having no recollection or knowledge of the vehicle's location. As such, the user associated with the vehicle has no indication of where to start looking for the vehicle.

To address this problem, the technology of the present disclosure allows the user associated with the vehicle to retrieve the vehicle's location (e.g., GPS coordinates) and have the location of the vehicle displayed via an augmented reality (“AR”) interface (e.g., AR Headset) using a user interface element. This can allow the user to see both the location of the vehicle and the location of the vehicle relative to the user's current field of view.

For instance, the vehicle may be a personal vehicle of the user, and the user may park the vehicle in a large parking area. Upon the user exiting the vehicle or the vehicle entering a parked state, the vehicle may upload its location to a user device associated with the user (or to a cloud platform). In some embodiments, the vehicle may determine if the user device is within a communication range (e.g., short range wireless protocol) before sending its location to the user device. When the user returns to the large parking area, the user device may determine the location of the vehicle and the vehicle's location relative to the user's current field of view and display the location of the vehicle as a user interface element (e.g., icon) above the vehicle based on the user's current field of view. More specifically, if the user device is positioned such that it is facing the location of the vehicle, the icon above the vehicle may be visible through a display device (e.g., augmented reality display) of the user device.

According to example embodiments of the present disclosure, a computing system (e.g., a spatial computing system) may determine the location of the vehicle and the location of the user device and generate augmented reality graphics (e.g., an icon) associated with the location of the vehicle within a three-dimensional augmented reality environment. In some embodiments, the augmented reality graphics (e.g., user interface element) may be a user selectable icon. For example, a user may select an image of a Mercedes® logo as their user-selectable icon, and the computing system may use the image of the Mercedes® logo to generate the augmented reality graphics.

The computing system may determine a field of view of a display device (e.g., augmented reality display) associated with the user device in the augmented reality environment. More specifically, the computing system may determine the field of view such that the display device (e.g., AR display) presents, as a two-dimensional image, the augmented reality graphics that may be within the three-dimensional augmented reality environment. In one embodiment, the augmented reality graphics may be displayed when the field of view of the display device aligns, or at least partially overlaps, with the location of the augmented reality graphics. In some embodiments, as the user device location approaches the location of the vehicle, the computing system may alter, update, or regenerate the augmented reality graphics to indicate the user device may be getting closer to or farther from the vehicle (e.g., an icon gets bigger as the user device approaches the vehicle). In one example, the user device and display device associated with the user device may be a head-wearable computing system, the head-wearable computing system being an AR computing system.

In some embodiments, the computing system may determine route data between the location of the vehicle and the location of the user device associated with the user. A software application (e.g., on a user device, on a vehicle computing system, on a cloud computing system) may receive the location of the vehicle and the location of the user device and determine a route between the locations. In some embodiments, the computing system may determine a relative location of the vehicle to the user device and use the relative location of the vehicle to determine a route to the location of the vehicle. The route may include navigational content indicative of different or distinguishable portions of the route. The navigational content and the route, in addition to the AR graphics associated with the location of a vehicle, may be displayed within the display device associated with the user device (e.g., AR headset). For example, the display device may display directional steps (e.g., “Turn Left in 100 yd”), a directional arrow corresponding to the directional steps, and the user-selectable icon above the location of the vehicle. In some embodiments, the route may be generated within the three-dimensional augmented reality environment as a pathway and displayed relative to the field of view of the display device (e.g., AR display). For example, the user looks at the ground within the display device and a pathway may be projected onto the ground indicating where to move to arrive at the vehicle or what direction to move to arrive at the vehicle. In one example, the computing system may be a remote computing system, separate from the user device and the display device.

In some embodiments, the computing system may receive the location of the vehicle after the vehicle has been turned off. More specifically, the computing system may receive the location of the vehicle by requesting it from the vehicle. For instance, the computing system may output a signal to wake up the vehicle, and in response to the signal, receive the location of the vehicle. For example, the computing system may be unable to retrieve the location of the vehicle until the location of the vehicle is requested by the user device. The computing system may output a wake-up signal to a remote computing system and, in return, receive the location of the vehicle from the remote computing system.

In some embodiments, the vehicle may be a service-based vehicle. For example, the vehicle may be associated with a transportation service (e.g., rideshare platform). The computing system may receive the location of the vehicle from the transportation service and determine augmented reality graphics for the vehicle associated with the transportation service. For instance, a user device may be running a software application from the transportation service and request a vehicle therein. The user device may receive the location of the vehicle from the software application associated with the transportation service and generate augmented reality graphics for the vehicle and the location of the vehicle associated with the transportation service as it approaches the user device. In one embodiment, the computing system may receive the location of the vehicle associated with the transportation service from the vehicle itself and determine augmented reality graphics associated with the vehicle based on the location received from the vehicle.

In some embodiments, the vehicle may be an autonomous vehicle and the augmented reality graphics may be displayed by the display device when the vehicle is approaching the location of the user device. For example, the computing system may receive the location of the autonomous vehicle as it is approaching the user and generate augmented reality graphics for the vehicle as it approaches the user device and subsequently the user. The display device may display the augmented reality graphics above the autonomous vehicle until the autonomous vehicle arrives at the user or user device.

The technology of the present disclosure provides a number of technical effects and computing improvements. For instance, the technology of the present disclosure improves the energy usage and internal computing technology of user computing devices. A user device may receive data indicative of the location of the vehicle associated with the user and determine an efficient route and directional steps to the location of the vehicle. The user device may output, to the display device associated with the user device, a signal indicating both the directional steps to the vehicle and the location of the vehicle relative to the user's current field of view. This technology leverages the user interface of a display device to provide the user with spatial awareness that may be difficult to render on another user device (e.g., a mobile phone). Accordingly, the user device and display device may allow the user to arrive at the location of the vehicle as quickly as possible and avoid wasting its own computing resources trying to locate the vehicle. In this way, the user device can more efficiently utilize its computing resources, as well as reduce energy otherwise wasted traversing the large parking area in search of the vehicle associated with the user.

Further, the technology of the present disclosure provides for an improved augmented reality interface based on location data from a user device associated with the AR interface. For instance, the technology of the present disclosure improves the display functionality and graphical generation techniques of a display device associated with the user device. For instance, a computing system may generate a first set of augmented reality graphics based on navigation content and route data from the location of the user device to the location of the vehicle. The computing system may also generate a second set of augmented reality graphics based on the field of view of the user device and the location of the user device. The computing system may output the first set of AR graphics and the second set of AR graphics to the display device providing improved functionality of the display device. In addition, the computing system may reduce energy usage and computing resource consumption of the display device by incorporating location data into generating AR graphics and determining the most efficient route to the location of the vehicle, reducing use time of the display device (e.g., AR display).

The technology of the present disclosure provides a number of technical effects and benefits for transportation services (e.g., rideshare programs). For instance, the technology of the present disclosure improves energy usage and computing resource efficiency for transportation services. A computing system may receive data indicative of the location of a vehicle associated with the transportation service and output augmented reality graphics to a display device (e.g., AR display) which allows a user to promptly and quickly identify the vehicle and the location of the vehicle associated with the transportation service. Accordingly, the computing system may avoid wasting either its own or another devices computing resources trying to identify the vehicle associated with the transportation service without knowing the location of the vehicle.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

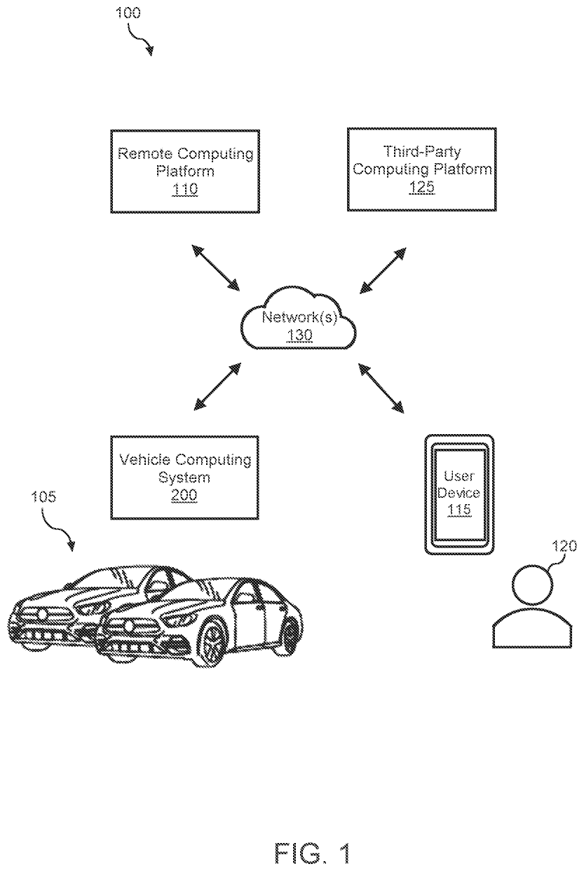

FIG. 1 illustrates an example computing ecosystem 100 according to an embodiment hereof. The computing ecosystem 100 may include a vehicle 105, a remote computing platform 110 (also referred to herein as computing platform 110), and a user device 115 associated with a user 120. The user 120 may be a driver of the vehicle 105. In some implementations, the user 120 may be a passenger of the vehicle 105. In some implementations, the computing ecosystem 100 may include a third party (3P) computing platform 125, as further described herein. The vehicle 105 may include a vehicle computing system 200 located onboard the vehicle 105. The computing platform 110, the user device 115, the third-party computing platform 125, and/or the vehicle computing system 200 may be configured to communicate with one another via one or more networks 130.

The systems/devices of computing ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that may be remote from the vehicle 105. In an embodiment, the computing platform 110 may include a cloud-based server system. The computing platform 110 may be associated with (e.g., operated by) an entity. For example, the remote computing platform 110 may be associated with an OEM that may be responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a vehicle computing system 200 of the vehicle 105 or the user device 115. The computing platform 110 may include one or more inter-service APIs for communication among its microservices. In some implementations, the computing platform may include one or more RPCs for communication with the user device 115.

The computing platform 110 may include one or more computing devices. For instance, the computing platform 110 may include a control circuit and a non-transitory computer-readable medium (e.g., memory). The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone, a camera or other imaging device, a motion sensor, etc. The user device 115 may include one or more output components such as a display device (e.g., AR display), a speaker, etc. For a wearable device such as a pair of smart-glasses, the display device may be formed/integrated into the lens of the glasses or the display device may have a form-figure in the shape of the lens.

In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the computing platform 110.

The third-party computing platform 125 may include a computing system that may be remote from the vehicle 105, remote computing platform 110, and user device 115. In an embodiment, the third-party computing platform 125 may include a cloud-based server system. The term “third-party entity” may be used to refer to an entity that may be different than the entity associated with the remote computing platform 110. For example, as described herein, the remote computing platform 110 may be associated with an OEM that may be responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that may be available to or downloaded on the vehicle computing system 200.

The third-party computing platform 125 may include one or more back-end services provided by a third-party entity. The third-party computing platform 125 may provide services that may be accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), or other types of services. The third-party computing platform 125 may host or otherwise include one or more APIs for communicating data to/from the third-party computing platform 125 to other systems/devices of the computing ecosystem 100.

In one embodiment, the third-party computing platform 125 may be utilized to retrieve the location of a vehicle 105 associated with a third-party transportation service (e.g., rideshare program). For instance, the third-party computing platform may receive a location of a vehicle 105 from network 130 and vehicle computing system 200 and transmit the location of the vehicle 105 over network 130 to user device 115. The user device 115 may generate augmented reality graphics based on the location of the vehicle 105 and output the augmented reality graphics to a display device (e.g., AR display) associated with the user device 115. In some examples, the third-party computing platform 125 may receive the location of the vehicle 105 from another user device not shown or the remote computing platform 110.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short-range communication techniques (e.g., Bluetooth low energy protocol, radio frequency signaling, NFC protocol).

The vehicle 105 may be a vehicle 105 that may be operable by the user 120. In an embodiment, the vehicle 105 may be an automobile or another type of ground-based vehicle that may be manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gears, etc. The power source(s) may include one or more types of power sources. For example, the vehicle 105 may be a fully electric vehicle (EV) that may be capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium, which may be external to the vehicle computing system 200, may act as an external buffer or repository for storing information. In such an example, the vehicle computing system 200 may retrieve or otherwise receive the information from the non-transitory computer-readable medium.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 may be onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105.

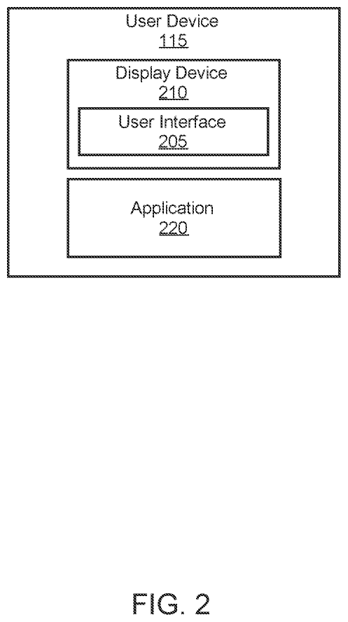

FIG. 2 illustrates a diagram of example components of the user device 115 according to an embodiment hereof. The user device 115 may include a display device 210 configured to render content (e.g., AR content) via a user interface 205 for presentation to a user 120. The display device 210 may include a display screen, AR lens, CRT, LCD, plasma screen, touch screen, TV, projector, tablet, or other suitable display components. In one embodiment, the display device 210 may be an augmented reality display of a wearable computing system. The user device 115 may include a software application 220 that may be downloaded and run on the user device 115. In some implementations, the software application 220 may be associated with the vehicle 105 or an entity associated with the vehicle 105 (e.g., manufacturer, retailer, maintenance provider). In an example, the software application 220 may enable the user device 115 to communicate with the computing ecosystem 100 and the services thereof.

The user device 115 may be configured to pair with the vehicle 105 via a short-range wireless protocol. The short-range wireless protocol may include, for example, at least one of Bluetooth®, Wi-Fi, ZigBee, UWB, IR. The user device 115 may pair with the vehicle 105 through one or more known pairing techniques. For example, the user device 115 and the vehicle 105 may exchange information (e.g., addresses, device names, profiles) and store such information in their respective memories. Pairing may include an authentication process whereby the user 120 validates the connection between the user device 115 and the vehicle 105.

Once paired, the vehicle 105 and the user device 115 may exchange signals, data, etc. through the established communication channel. For example, the head unit of the vehicle 105 may exchange signals with the user device 115.

The technology of the present disclosure allows the vehicle computing system 200 to extend its computing capabilities by leveraging the computing resources of the user device 115. More particularly, the vehicle computing system 200 may leverage the user device 115 to present navigational content to locate the vehicle 105. As described herein, this technology can overcome potential inefficiencies introduced by locating the vehicle 105 without knowledge of the vehicle 105 location, or visibility of the vehicle 105.

The following describes the technology of the present disclosure within the context of examples. For instance, example embodiments include pairing between a user device 115 (e.g., wearable device) and a vehicle 105 for facilitation of content presentation based on location data from the vehicle 105. This example is meant for illustrative purposes and is not meant to be limiting. In some implementations, the user device 115 (e.g., wearable device) may be in communication with a user device 115 (e.g., a user's mobile phone through a pairing procedure). The user device 115 may be connected to (e.g., paired with) the vehicle 105 or another computing system (e.g., a cloud based platform). The user device 115 can serve as an intermediate to facilitate content generation in a manner similar to that described below for the vehicle computing system 200. Additionally, or alternatively, a remote computing system (e.g., cloud-based platform) can serve as such an intermediary.

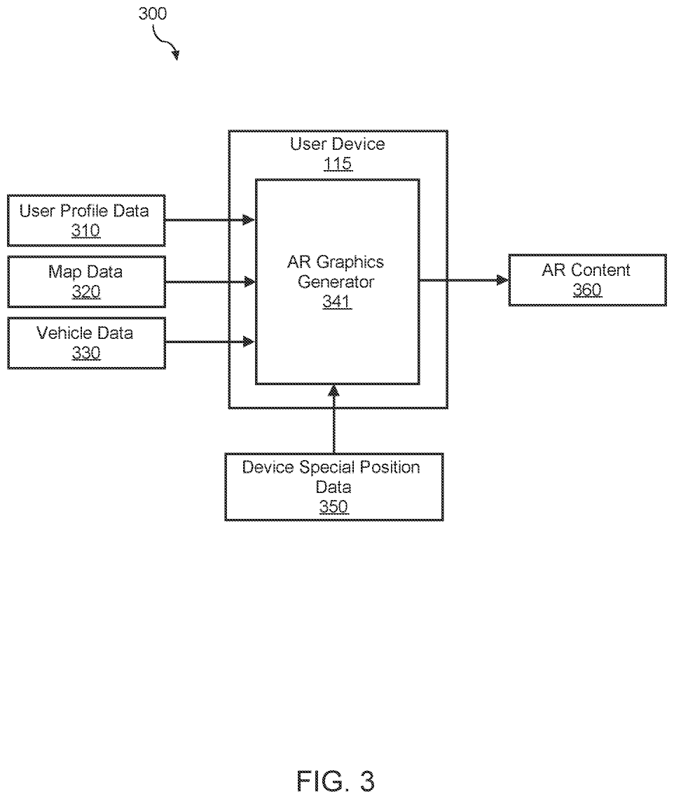

FIG. 3 illustrates an example dataflow pipeline 300 according to an embodiment hereof. The following description of dataflow in the dataflow pipeline 300 is described with an example implementation in which the user device 115 utilizes an AR graphics generator 341 to process user profile data 310, map data 320, vehicle data 330, and device spatial position data 350 to generate AR content 360 indicative of a location of the vehicle 105 based on one or more portions of the user profile data 310, map data 320, vehicle data 330, or device spatial position data 350. Additionally, or alternatively, one or more portions of dataflow pipeline 300 may be implemented within the vehicle computing system 200 of the vehicle 105, or the remote computing platform 110. In some embodiments, the user profile data 310, map data 320, vehicle data 330, and device spatial position data 350 may be obtained from the software application 220 depicted in FIG. 2. For example, the software application 220 may communicate with the vehicle computing system 200 of the vehicle 105 and determine the location of the vehicle 105.

The AR graphics generator 341 may receive user profile data 310 indicating one or more user preferences of the user 120 (e.g., vehicle operator). User preferences may indicate one or more graphics preferences of the vehicle operator. For instance, user preferences may include a user selected icon to be displayed, a range for when to display certain AR graphics, a range for when not to display certain AR graphics, a preferred navigation software, or similar. For instance, user profile data 310 may include a user selectable icon of the Mercedes® logo and when generating AR content 360, the AR graphics generator 341 uses the icon of the Mercedes® logo to signify the location of the vehicle 105. In another example, the user selectable icon may include an animal, symbol, avatar, user defined graphic/art, etc. The icon may be static or dynamic (e.g., rotating logo, dancing animal). In some embodiments, the size, shape, color, or other visual elements of the user selectable icon may be selected by the user 120.

The AR graphics generator may receive map data 320 indicating a map of the environment including the location of the vehicle 105. For instance, map data 320 may include a route from the location of the user device 115 to the vehicle 105. The map data 320 may include parking areas associated with the vehicle 105 or parking areas in general. In an embodiment, the map data 320 may include restriction metadata. Restriction metadata may be indicative of a restriction associated with routes for vehicle 105 or the user 120 to traverse. For example, in determining a route from the user 120 to the vehicle 105, there may be a blockade on a walkway that restricts a person from traveling along the walkway, but may be suitable for a vehicle route.

The AR graphics generator 341 may receive vehicle data 330 indicating location data (e.g., the current location of the vehicle) for the vehicle 105. For instance, the vehicle computing system 200 may generate one or more control signals to output the location of the vehicle 105 to the user device 115 when the vehicle 105 is put into a parked state (e.g., the parking brake is applied, or the transmission is shifted into park, or the vehicle computing system 200 is directed to enter a parked mode). In one embodiment, the vehicle computing system 200 may determine if the user device 115 is within a communication range and output its location directly to the user device 115. The communication range may be defined as the area where a device, such as user device 115, may communicate with the vehicle computing system 200 using a short-range wireless protocol. The short-range wireless protocol may include, for example, at least one of Bluetooth®, Wi-Fi, ZigBee, UWB, IR. In another embodiment, the user device 115 may determine if the vehicle 105 and vehicle computing system 200 are within a communication range.

The AR graphics generator 341 may obtain device spatial position data 350 from one or more sensors of the user device 115. Device spatial position data 350 may include a plurality of measurements indicating, for example, the orientation, direction, roll, pitch, yaw, position, or similar of the user device 115. For instance, the plurality of measurements may indicate the user device is facing North and looking with 0 degree pitch, yaw, and roll (e.g., the user is facing north looking straight ahead). By way of example, the user 120 may be wearing the user device 115 on their face as a headset and is looking straight, parallel to the ground, and ahead to the north. The position of their head and direction may be input to the AR graphics generator 341 as device spatial position data 350 for determining the field of view of the user device 115 and subsequently the user 120.

In some examples, the AR graphics generator 341 may include one or more machine-learned models. The AR graphics generator 341 may include one or more machine-learned models that utilize the user profile data 310, map data 320, vehicle data 330, and device spatial position data 350 to generate AR content 360 indicative of the location of the vehicle 105. In an embodiment, while not shown, the AR graphics generator 341 may be on a remote computing platform 110 and transmit the AR content 360 to the user device 115.

In an embodiment, the AR graphics generator 341 may include a machine learned model that may be an unsupervised or supervised learning model configured to generate AR graphics. For example, the AR graphics generator 341 may include a machine-learned model trained to generate AR content 360 (e.g., AR graphics). In some examples, the AR graphics generator 341 may include a machine-learned model trained to identify vehicles such as the vehicle 105 associated with the user 120 and determine a position of the AR content 360 (e.g., AR graphics) relative to the vehicle 105.

Machine-learned models utilized by the AR graphics generator 341 may be or may otherwise include various types of models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The AR graphics generator 341 may be trained through the use of one or more model trainers and training data. The model trainers may be trained using one or more training or learning algorithms. One example training technique may be backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating a vehicle 105 associated with the user 120. In some examples, the training data may include simulated training data (e.g., training data obtained from simulated scenarios, inputs, configurations, various parking areas, etc.).

Additionally, or alternatively, the model trainer(s) may perform unsupervised training techniques using unlabeled training data. By way of example, the model trainer(s) may train one or more components of a machine-learned model to identify a vehicle 105 associated with the user 120 and determine a position of the AR content 360 (e.g., AR graphics) relative to the vehicle 105 using unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The user device 115 may output AR content 360 based on the AR graphics generator 341. AR content 360 may include computer generated content integrated into the real world. For instance, the AR graphics generator 341 may generate AR content 360 such as, for example, a user interface element which may be displayed on the user device 115 (e.g., AR glasses). The user device 115 may determine a route which leads to the location of the vehicle 105 and generate AR content which indicates content for navigating to the location of the vehicle 105. The route may be based on map data 320. In an embodiment, the route may be determined based on the vehicle data 330, which may indicate a location of the vehicle 105.

The user device 115 may generate AR content 360 indicating user interface elements such as navigational indicators and output one or more signals to initiate a display of the AR content 360 via the user device 115 (e.g., AR glasses). The one or more signals may be communicated via one or more wired connections, one or more networks, or via near field communication techniques. The AR glasses may display the AR content 360 and indicate a path which leads to the location of the vehicle 105.

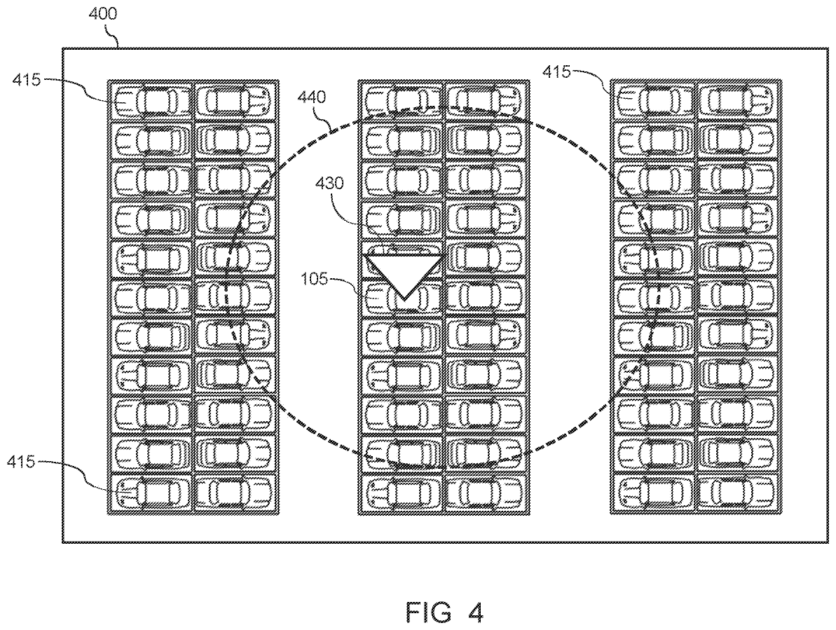

Referring now to FIG. 4, an example diagram 400 of a parked vehicle of an embodiment hereof may be provided. A vehicle 105 associated with a user may be parked in a parking area 410. The parking area 410 may be filled with a plurality of non-user associated vehicles 415 making the vehicle 105 difficult to locate. In accordance with example aspects of the present disclosure, a user device 115 may generate a user interface element 430 to identify the location of the vehicle 105 associated with the user 120. For instance, the user device 115 may display a user interface element 430, such as a user selectable icon, as the AR content 360 above the vehicle 105. By way of example, the user selectable icon may be selected by a user 120 to be a Mercedes® logo and the Mercedes® logo may be displayed as the user interface element 430 above the vehicle 105. The user selectable icon may be displayed such that it may be above the vehicle 105 and visible within a display device over the plurality of non-user associated vehicles 415. In one embodiment, the user interface element 430 may be visible in front of the plurality of non-user associated vehicles 415 (e.g., a user 120 can see the location of the vehicle 105 through the plurality of non-user associated vehicles 415).

In some examples, the vehicle 105 may have a communication range 440 around the vehicle 105 associated with the user 120. The communication range 440 may be an area in which the user device 115 may be able to directly retrieve the location of the vehicle 105 from the vehicle 105. The communication range 440 may be associated with a short-range wireless protocol (e.g., the distance/range a data packet or communication can travel via the protocol). The short-range wireless protocol may include, for example, at least one of Bluetooth®, Wi-Fi, ZigBee, UWB, IR.

In one embodiment, the vehicle 105 may be placed into a parked state and determine whether the user device 115 may be within the communication range 440. If the user device 115 is within the communication range 440, then the vehicle 105 may send the location of the vehicle 105 to the user device 115. For example, a user 120 may enter a parking area 410 and park the vehicle 105 at a given location. Upon entering a parked state, the vehicle 105 may determine that the user device 115 may be within an ultra-wideband range of the vehicle 105 and send the location of the vehicle 105 to the user device 115. In one embodiment, the user device 115 may determine if the user device 115 may be within the communication range 440 of the vehicle 105 and, if so, retrieve the location of the vehicle 105 from the vehicle 105.

In some examples, the user device 115 may automatically request and retrieve the location of the vehicle 105 from the vehicle 105 when it enters the communication range 440. In one embodiment, the user device 115 may generate AR content 360 associated with the location of the vehicle 105 upon the user device 115 entering the communication range 440. For example, a user 120 may be returning to the parking area 410 to retrieve their vehicle 105. Upon entering the communication range 440 of the vehicle 105, the user device 115 (e.g., AR headset) may retrieve the location of the vehicle 105 from the vehicle 105 (or another system) and generate AR content 360 indicative of a user interface element 430, such as a user selectable icon (e.g., Mercedes® Logo), at the location of the vehicle 105.

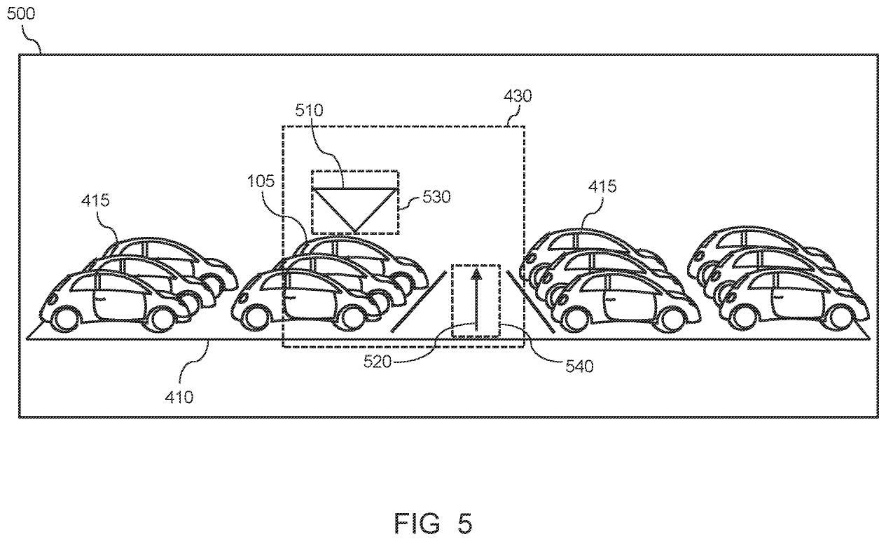

FIG. 5 illustrates an example augmented reality display 500 according to example embodiments hereof. The augmented reality display 500 may display augmented reality graphics such as, for example, the user interface element 430 depicted in FIG. 4. The augmented reality display 500 may display the user interface element 430 indicative of the user selectable icon 510 associated with the vehicle 105. In some embodiments, the augmented reality display 500 may display the user interface element 430 including a first set of augmented reality graphics 530 and a second set of augmented reality graphics 540. In one embodiment, the first set of AR graphics 530 may include a user selectable icon 510 and the second set of AR graphics 540 may include a pathway 520.

The user interface element 430 may be generated by the AR graphics generator 341, as seen in FIG. 3, based on the device spatial position data 350 indicative of the field of view of the user device 115. For example, the first set of AR graphics 530 of the user interface element 430 may be generated on the augmented reality display 500 when the first set of AR graphics 530 may be within the field of view of the user device 115. More specifically, the user device 115 may be a wearable AR device (e.g., AR headset) and, when the user device 115 is facing the location of the vehicle 105, the user interface element 430 may be displayed including the user selectable icon 510 above the vehicle 105 as depicted in FIG. 5. Similarly, when the user device 115 is facing the direction of the location of the vehicle 105, or the direction to reach the location of the vehicle 105, the second set of augmented reality graphics 540, including the pathway 520, may be displayed by the wearable AR device. In some implementations, the pathway 520 may be displayed even if the user device 115 is facing a different direction than the location of the vehicle 105. In one embodiment, the user interface element 430 including the second set of augmented reality graphics 530 may be generated by the AR graphics generator 341 and displayed on the AR display 500.

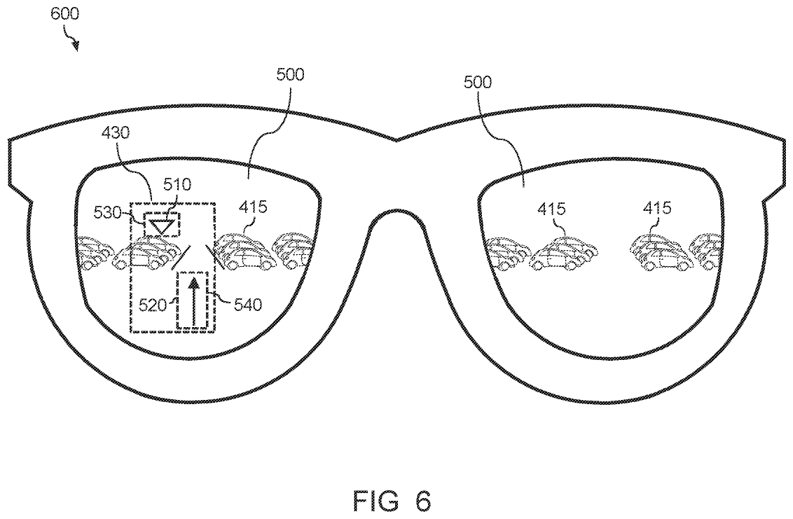

FIG. 6 illustrates an example augmented reality device 600 according to example embodiments hereof. The augmented reality device 600 may, in some instances, be the user device 115. As such, the augmented reality device 600 may include the display device 210 and display, for example, the augmented reality display 500 from FIGS. 5 & 6. In some embodiments, the augmented reality device 600 may include the AR graphics generator 341 illustrated in FIG. 3. For instance, the augmented reality device 600 may include the AR graphics generator 341 and generate AR content 360 for display via the AR display 500. The augmented reality device 600 may generate AR content 360 that includes the user interface element 430 including first set of augmented reality graphics 530 and the second set of augmented reality graphics 540. The first set of augmented reality graphics 530 may include the user selectable icon 510 and the second set of augmented reality graphics 540 may include the pathway 520. In accordance with example aspects of the present disclosure, when the augmented reality device 600 is facing the location of the vehicle 105, the first set of AR graphics 530 may be displayed via AR display 500. It should be appreciated that any portion of the user interface element 430 may be displayed when facing the location of the vehicle 105. For instance, the first set of AR graphics 530 of the user interface element 430 may be the user selectable icon 510 (e.g., a dinosaur) and may be displayed while facing the location of the vehicle 105, whereas the second set of AR graphics 540, including the pathway 520, may always be displayed by the AR display 500 of the AR device 600.

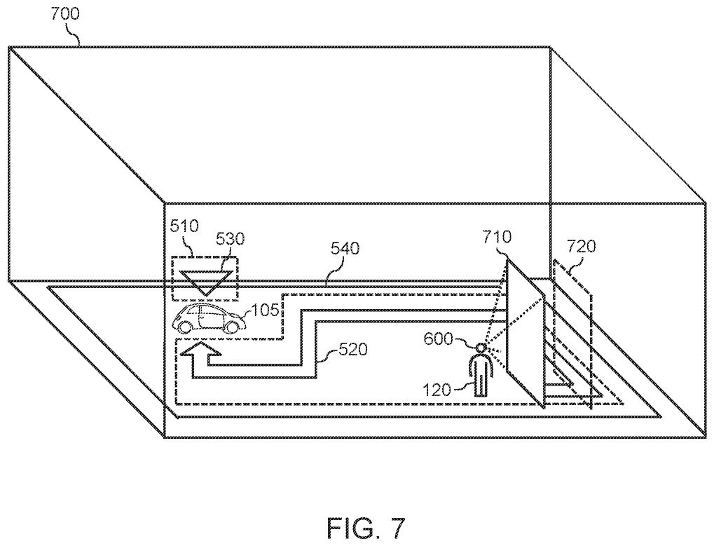

FIG. 7 illustrates an example augmented reality environment 700 according to an example embodiment hereof. The AR environment 700 may include a combination of physical and virtual features such as, for example, the user interface element 430, including the first set of augmented reality graphics 530 and the second set of augmented reality graphics 540, and the vehicle 105. The AR environment 700 may be a three-dimensional space as depicted in FIG. 7. The AR environment may include a field of view 710 of the user 120 and the AR device 600. The field of view 710 may be used to determine what, if any, AR graphics should be displayed by the AR device 600 on, for example, the AR display 500. The field of view 710 may be used to determine a two-dimensional projection 720 of the three-dimensional AR environment 700. For example, the AR device 600 may include a two-dimensional screen such as, for example, the AR display 500. The two-dimensional projection 720 may be used to display the three-dimensional contents of the AR environment 700 on the two-dimensional AR display 500 of the AR device 600.

In one example, a user 120 may be wearing the AR device 600 such as, for example, AR glasses. The AR device 600 may generate the AR environment 700 including the first set of AR graphics 530, including the user selectable icon 510, and the second set of AR graphics 530, including the pathway 520. When the user 120, and in turn the AR device 600, faces the location of the vehicle 105, the user selectable icon 510 may be displayed above the vehicle 105 along with the pathway 520 leading to the vehicle 105. More specifically, one or more sensors (e.g., gyroscope, accelerometer, camera, RADAR, etc.), alone or in combination, within the AR device 600 may determine that the AR device 600 is facing the location of the vehicle 105. Similarly, one or more sensors (e.g., cameras) may determine a field of view of the user 120 and the AR device 600 (e.g., user device 115). The field of view may be a window of everything visible by the user 120 or the AR device 600. The AR device 600 may display the user selectable icon 510 above the vehicle 105 when the AR device 600 is facing the location of the vehicle 105 and the location of the vehicle 105 is within the field of view of the AR device 600 or the user 120. For example, a gyroscope within the AR device 600 may determine data indicative of the angle and direction the AR device 600 is facing and the AR device 600 may use the data from the gyroscope to determine whether to display the user selectable icon 510. In some embodiments, the AR environment 700 may be generated by the user device 115 and AR graphics generator 341. For instance, the AR graphics generator 341 of the user device 115 may generate the AR environment 700 using the device spatial position data 350, map data 320, user profile data 310, and vehicle data 330. It should be appreciated that any computing system in the computing ecosystem 100 shown in FIG. 1 may generate the AR environment 700.

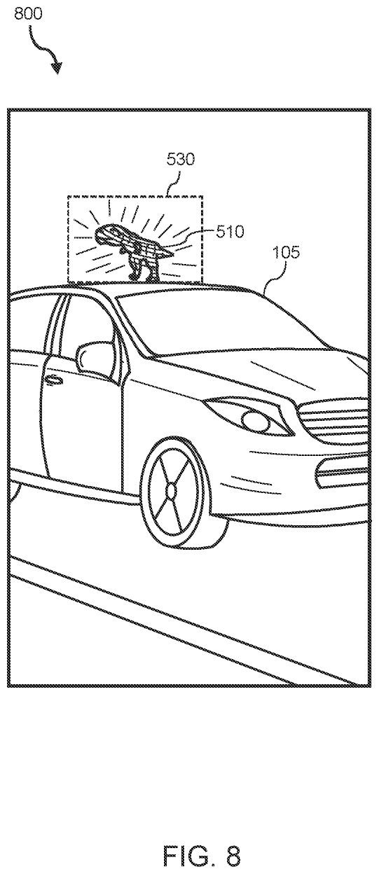

FIG. 8 illustrates an example augmented reality display 800 as a vehicle 105 approaches the AR display 800 according to examples embodiments hereof. The AR display 800 may be associated with a user device 115 such as, for example, the AR device 600. As such, the display device 210 of the user device 115 may be associated with the AR display 800. In some embodiments, the vehicle 105 may be associated with a transportation service (e.g., rideshare platform). The location of the vehicle 105 may be received by the user device 115 from a third-party computing platform 125 as shown in FIG. 1 such as, for example, a transportation service (e.g., rideshare platform). In some embodiments, the AR display 800 may display the first set of AR graphics 530 including the user selectable icon 510 above the vehicle 105 as the vehicle approaches the AR display 800.

By way of example, the AR display 800 may be part of the user device 115 running the software application 220 associated with a transportation service. The user device may request the vehicle 105 from the transportation service. As the vehicle 105 approaches the location of the user device 115, the location of the vehicle 105 may be received by the user device 115 via the transportation service. The user device 115 may generate the AR display 800, including the user selectable icon 510 above the location of the vehicle 105. In some embodiments, the user device 115 may receive the location of the vehicle 105 from the vehicle 105 or another remote computing system (e.g., the cloud platform 110) to generate the AR display 800. In an embodiment, the remote computing system may receive the location of the vehicle 105 (e.g., the ridesharing vehicle) from a third party computing system (e.g., of the ridesharing platform).

In some embodiments, the vehicle 105 may be an autonomous vehicle. The AR display 800 may display the user interface element 430 including the user selectable icon 510 above the vehicle 105 as it approaches the AR display 800. For example, the AR display 800 may be associated with the user device 115. The user 120 may, via the user device 115, request the vehicle 105 to pick them up. The user device 115 may receive the location of the vehicle 105 and the display device 210 associated with the user device 115 may display AR display 800. The AR display 800 may include the user selectable icon 510 above the vehicle 105.

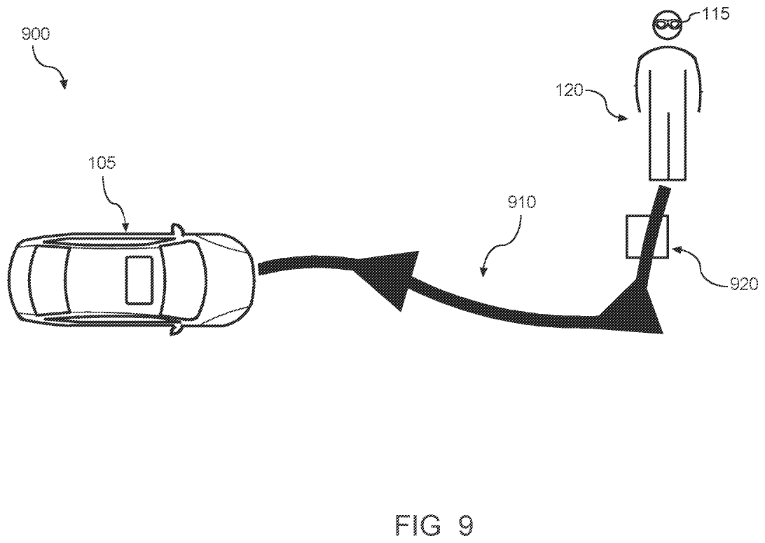

FIG. 9 illustrates example navigation data 900 according to example embodiments hereof. In one embodiment, the user device 115 may determine navigation data 900 including a route 910 to the location of the vehicle 105 from the user device 115. For instance, the user 120 may request the user device 115, such as the AR device 600, to display the location of the vehicle 105 using the display device 210 and generate, for example, the AR display 500 or AR display 800. The user device 115 may determine navigation data 900 and provide the route 910 to the user 120 so the user 120 may move to the location of the vehicle 105. In one embodiment, the route 910 may be used by the user device 115 to generate the pathway 520 as shown in FIGS. 5, 6, and 7.

In an embodiment, the user 120 may initiate a request for the AR device 600 to display the location of the vehicle 105 using voice commands. For instance, the user 120 may speak a voice command (e.g., verbal command) to display the location of the vehicle 105. Example voice commands may include “Hey Mercedes®” commands or any other verbal commands. For example, the user 120 may interact with a Mercedes® virtual assistant running on the vehicle 105 via the AR device 600 by speaking the wake words “Hey Mercedes®”. Wake words may cause a the AR device 600 to record the voice (e.g., voice commands) of the user 120 and transmit the recording to the Mercedes® virtual assistant (e.g., vehicle 105). In an embodiment the Mercedes® virtual assistant may initiate a request to cause the AR device 600 to display the location of the vehicle 105.

In an embodiment, the user 120 may initiate a request for the AR device 600 to display the location of the vehicle 105 using physical commands (e.g., physical gestures). For instance, the user 120 may perform physical gestures (e.g., hand movements, head movements, eye blinking, touching the AR, device 600, etc.) to interact with one or more software applications running on the AR device 600 to display the location of the vehicle 105. For example, software applications running on the AR device 600 may generate one or more interactable AR projections (e.g., AR graphics 540) displayed on the AR device 600. The user 120 may perform one or more physical gestures to interact with the AR projections to cause the AR device 600 to display the location of the vehicle 105. By way of example, the user 120 may interact with a map AR projection using a first hand gesture (e.g., pointing, touching, etc.) to focus the map AR projection on a region which displays a representation (e.g., AR projection) of the parking area 410. The user may interact with the AR projection representing the parking area 410 using a second hand gesture (e.g., pointing, touching, etc.) to indicate the intent of the user 120 to locate the vehicle 105. The AR device 600 may determine the intent of the user 120 to locate the vehicle 105 and display the location of the vehicle 105. In an embodiment, a combination of voice commands and physical commands may be used to indicate the intent of the user 120 and display the location of the vehicle 105.

In some embodiments, the navigation data 900 may include navigation content 920 based on distinguishable portions of the route 910. The route 910 may be used to develop the navigation content 920 including information for navigating from the location of the user device 115 to the vehicle 105. For example, the navigation data 900 may include the route 910 from the location of the user device 115 to the location of the vehicle 105, and the user device 115 may determine navigation content 920 from the route 910. The navigation content 920 may be procedural steps for navigating from the location of the user device 115 to the vehicle 105 (e.g., “Turn left in 200 yd”). The navigation content 920 (e.g., directional steps) may be displayed via the user device 115 such as, for example, the AR device 600. In this way, the user 120 may be able to locate the vehicle 105 by following the navigation content 920.

In some embodiments, the navigation data 900 may be based on the location of the vehicle 105 relative to the user device 115. For example, the navigation data 900 may include the route 910 based on the location of the vehicle 105 relative to the user device 115. In this manner, the navigation content 920 may be determined for portions of the route 910 from the location of the vehicle 105 relative to the user device 115. For example, the location of the vehicle 105 or the user device 115 may be dynamic, therefore the navigation data 900 may be determined based on the location of the vehicle 105 relative to the user device 115. It should be appreciated that the navigation data 900 may be determined by any computing system from the computing ecosystem 100 shown in FIG. 1. For example, the computing system 110 may determine the navigation data 900 including the route 910 and navigation content 920.

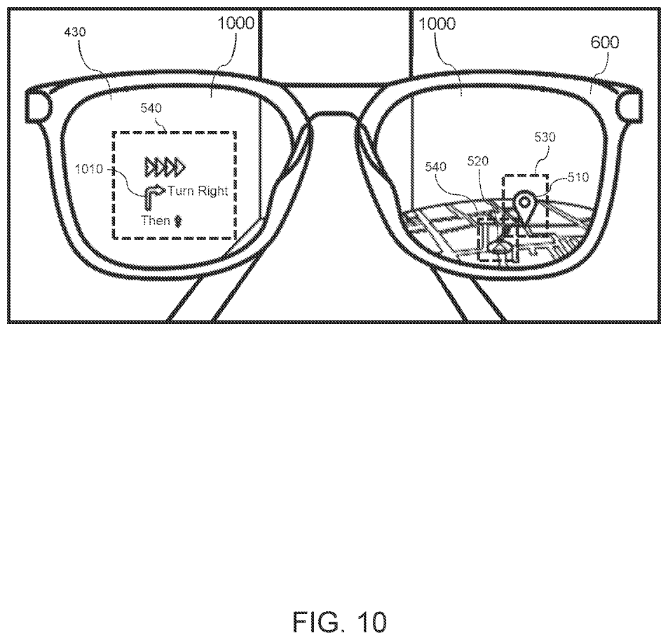

FIG. 10 illustrates an augmented reality display 1000 according to an example embodiment hereof. The AR display 1000 may include the user interface element 430 including the first set of augmented reality graphics 530 and the second set of augmented reality graphics 540. The first set of AR graphics 530 may include the user selectable icon 510, and the second set of AR graphics may include the pathway 520 and the directional steps 1010. The directional steps 1010 may be based on the navigation content 920 as illustrated in FIG. 9, provide information associated with the route 910, and describe how to navigate to the location of the vehicle 105. For example, the directional steps 1010 may indicate the user 120 may turn right in a specified distance to arrive at the location of the vehicle 105. In one embodiment, the first set of AR graphics 530, of the user interface element 430, are displayed in the AR display 1000 when the location of the vehicle 105 may be in the field of view of the AR display 1000. Whereas the second set of AR graphics of the user interface element 430 may be constantly displayed by the AR display 1000.

In one embodiment, the AR display 1000 may be generated by the user device 115 using the AR graphics generator 341 shown in FIG. 3. More specifically, the user device 115 may use the AR graphics generator 341 to generate AR content 360 including the user interface element 430. The user interface element 430 may include the first set of AR graphics 530 and the second set of AR graphics 540. The first set of AR graphics may include the user selectable icon 510 and the second set of AR graphics 540 may include the directional steps 1010 and the pathway 520. In one embodiment, the AR display 1000 may be displayed by the AR device 600. It should be appreciated that the AR display 1000 may be generated by any computing system in the computing ecosystem 100 shown in FIG. 1, for example the remote computing platform 110.

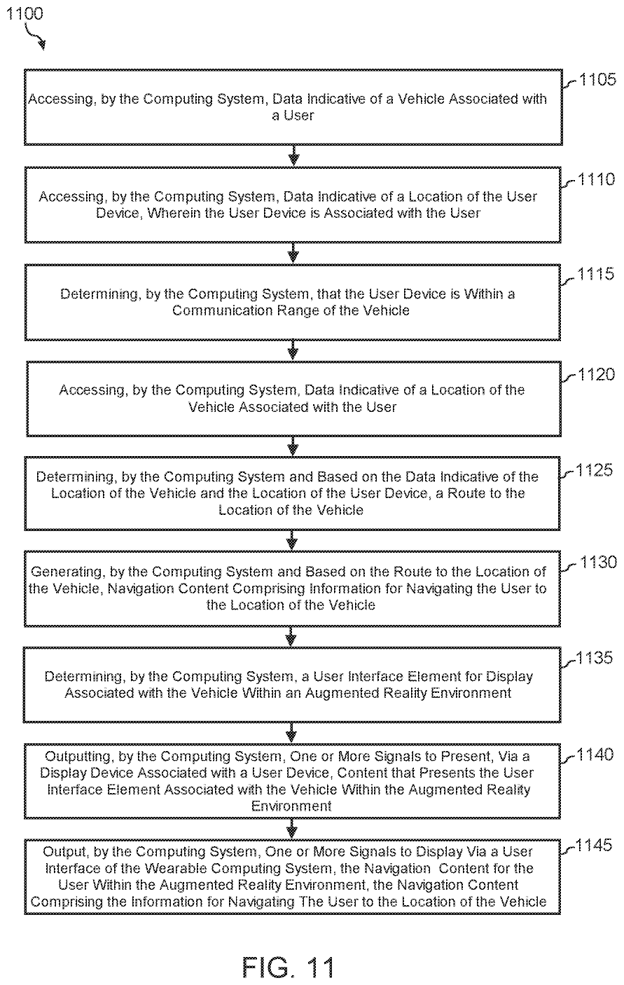

FIG. 11 illustrates a flow diagram that depicts an example method 1100 for locating a vehicle and generating augmented reality graphics according to an embodiment hereof. The method 1100 may be performed by a computing system described with reference to the other figures. In an embodiment, the method 1100 may be performed by the user device 115 of the computing ecosystem 100 of FIG. 1. One or more portions of the method 1100 may be implemented as an algorithm on the hardware components of the devices described herein (e.g., as in FIGS. 1-3, 6, and 10), for example, to generate augmented reality graphics as described herein. For example, the steps of method 1100 may be implemented as operations/instructions that are executable by computing hardware.

FIG. 11 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 11 is described with reference to elements/terms described with respect to other systems and figures, for example, illustrated purposes, and is not meant to be limiting. One or more portions of method 1100 may be performed additionally, or alternatively, by other systems. For example, method 1100 may be performed by a control circuit of the computing platform 110. In another example, method 1100 may be performed by a computing system of the user device 115.

In an embodiment, the method 1100 may begin with or otherwise include an operation 1105, in which a computing system (e.g., user device 115, computing platform 110) accesses data indicative of a vehicle 105 associated with a user 120. For instance, the data indicative of the vehicle 105 may indicate the vehicle 105 may be owned by the individual using the user device 115, user 120. In one embodiment, the data may indicate that the vehicle 105 may be a personal vehicle of the user 120. In another embodiment, the data may be provided by a transportation service (e.g., rideshare program), indicate that the vehicle 105 may be associated with a transportation service (e.g., rideshare program), and the vehicle 105 may be assigned to the user 120 or user device 115.

The method 1100 in an embodiment may include an operation 1110, in which the computing system (e.g., user device 115, computing platform 110) may access data indicative of a location of the user device 115. As described herein, the user device 115 may be associated with the user 120 such that it is owned or operated by the user 120. the computing system (e.g., the user device 115, computing platform 110) may determine the location of the user device 115 via one or more sensors (e.g., RADAR, Camera, SONAR) or antennas (BT, GPS, Wi-Fi, LTE) within the user device 115. The data may indicate the location of the user device 115 within a parking area or relative to the parking area.

The method 1100 in an embodiment may include an operation 1115, in which the computing system (e.g., the user device 115, computing platform 110) may determine that the user device 115 is within a communication range 440 of the vehicle 105. The computing system may determine that the user device 115 is within the communication range 440 based on the location of the user device 115. For instance, the computing system may determine if the vehicle 105 may be close enough to the user device 115 to transmit data such as, for example, the location of the vehicle 105. The user device 115 may include one or more antennas configured to communicate via a short-range wireless protocol. The short-range wireless protocol may include, for example, at least one of Bluetooth®, Wi-Fi, ZigBee, UWB, IR. The user device 115 may determine if the vehicle 105 may be within a communication range of a short-range wireless protocol for the user device 115. The communication range may be the maximum distance the user device 115 and vehicle 105 may communicate via a short-range wireless protocol.

The method 1100 in an embodiment may include an operation 1120, in which the computing system (e.g., user device 115, computing platform 110) may access data indicative of a location of a vehicle associated with a user. For instance, the computing system may receive the location of the vehicle 105 from the vehicle 105 itself or another system. By way of example, the user 120 may exit a structure near a large parking area. The user 120 may want to find the vehicle 105 within the parking area. The location of the vehicle 105 may be, for example, a location of the vehicle 105 within the parking area.

In some embodiments, the computing system may receive the location of the vehicle 105 from the vehicle 105 after the vehicle 105 is parked. In some embodiments, the vehicle 105 may provide the location of the vehicle 105 when it has entered a park state (e.g., turned off, parking brake applied, etc.) and the user device 115 has determined the vehicle 105 may be within a communication range of the user device 115. In one embodiment, the user device 115 may request the location of the vehicle 105 from the vehicle computing system 200.

In some embodiments, the computing system may output one or more signals to wake up the vehicle 105. For example, the computing system (e.g., the computing platform 110) may output one or more signals to wake up the vehicle 105. Additionally, or alternatively, the computing system (e.g., the user device 115) may request that another computing system output signals to wake up the vehicle 105. Waking up the vehicle 105 may include the vehicle 105 changing to a state whereby it can provide data to a computing system that is offboard the vehicle 105.

In response to the one or more signals to wake up the vehicle 105, the computing system may receive (e.g., from the vehicle 105) the data indicative of the location of the vehicle 105 from another intermediate computing system. For example, it should be appreciated the user device 115 may receive the location of the vehicle 105 from any of the computing systems or platforms in the computing ecosystem 100.

The method 1100 in an embodiment may include an operation 1125, in which the computing system (e.g., the user device 115, computing platform 110) may determine, based on the data indicative of the location of the vehicle 105 and the location of the user device 115, a route 910 to the location of the vehicle 105 from the location of the user device 115. For instance, the computing system may determine a route 910 from the user device 115, and the user 120, to the vehicle 105 (e.g., for the user 120 to traverse the parking area to arrive at the vehicle 105). In some embodiments, determining the route to the location of the vehicle 105 may include determining, based on the location of the vehicle 105 and the location of the user device 115, a relative location of the vehicle 105 to the user device 115, and determining the route 910 to the location of the vehicle 105 based on the relative location of the vehicle 105 to the user device 115.

By way of example, the route 910 may include a pathway that leads the user 120 around other vehicles or obstacles within the parking area to arrive at the vehicle 105. The route 910 may be a quickest route 910 to the vehicle 105. Additionally, or alternatively, the route 910 may be a shortest route to the vehicle 105. In some embodiments, the route 910 may avoid other parking spaces regardless of whether the parking spaces are occupied or not.

The method 1100 in an embodiment may include an operation 1130, in in which the computing system (e.g., the user device 115, the computing platform 110) may generate, based on the route to the location of the vehicle 105, navigation content including information for navigating the user device 115, and user 120, to the location of the vehicle 105. For instance, the computing system may determine navigation content including directional steps 1010 based on the route 910 to direct the user 120, to the location of the vehicle 105. This may include, for example, direction steps for the user 120 to walk to the location of the vehicle 105 from the exit of the structure, through the parking area.

The method 1100 in an embodiment may include an operation 1135, in which the computing system (e.g., user device 115, computing platform 110) may determine a user interface element 430 for display associated with the vehicle 105 within an augmented reality environment 700. The user interface element 430 may be a user selectable icon 510 associated with the vehicle 105 in the AR environment 700. In some embodiments, the user interface element 430 may be an icon 510 above the location of the vehicle 105.

In some embodiments, determining the user interface element 430 for display associated with the vehicle 105 within the augmented reality environment may include generating a first set of augmented reality graphics 530 based on the field of view 710 of the user 120 or user device 115 and the location of the user device 115; and generating a second set of augmented reality graphics 540 based on the navigation content and the route 910 to the location of the vehicle 105. In some embodiments, the second set of augmented reality graphics 540 may include the directional steps 1010 for moving from the location of the user device 115 to the location of the vehicle 105, based on the navigation content; and a pathway 520, based on the route 910 to the location of the vehicle 105, indicative of where to move to arrive at the vehicle 105. For instance, the user device 115 may determine, for display, an icon 510 above the location of the vehicle 105, directional steps 1010 for how to navigate to the vehicle 105, and a pathway 520 indicating the direction to move to arrive at the vehicle 105 (e.g., by traversing the parking area).

The method 1100 in an embodiment may include an operation 1140, in which the computing system (e.g., user device 115, computing platform 110) may output one or more signals to present, via the display device 210 associated with the user device 115, content that presents the user interface element 430 associated with the vehicle 105 within the augmented reality (AR) environment. For instance, the user device 115 may display content including the first set of AR graphics 530 via the display device of the user device 115. In some embodiments, the user device 115 may be a wearable computing system and the display device 210 associated with the user device 115 may be an augmented reality display, as described herein. For example, the user device 115 may be an AR headset and the user device 115 may display the first set of AR graphics 530 to provide the location of the vehicle 105 when the location of the vehicle 105 may be within the field of view 710 of the user device 115 and user 120. The user 120 may follow the icon 510 to arrive at the location of the vehicle 105.

The method 1100 in an embodiment may include an operation 1145, in which the computing system (e.g., user device 115, computing platform 110) may output one or more signals to display, via a user interface 205, the navigation content for the user 120 within the augmented reality (AR) environment. The navigation content may include the information for navigating the user 120 to the location of the vehicle 105. For instance, the user device 115 may display content including the second set of AR graphics 540 via the display device 210 of the user device 115. For example, as described herein, the user device 115 may be an AR headset and the user device 115 may display the second set of AR graphics 530 including directional steps 1010 and the pathway 520 for navigating the user 120 to the location of the vehicle 105. The user 120 may follow the directional steps 1010 or the pathway 520 to arrive at the location of the vehicle 105.

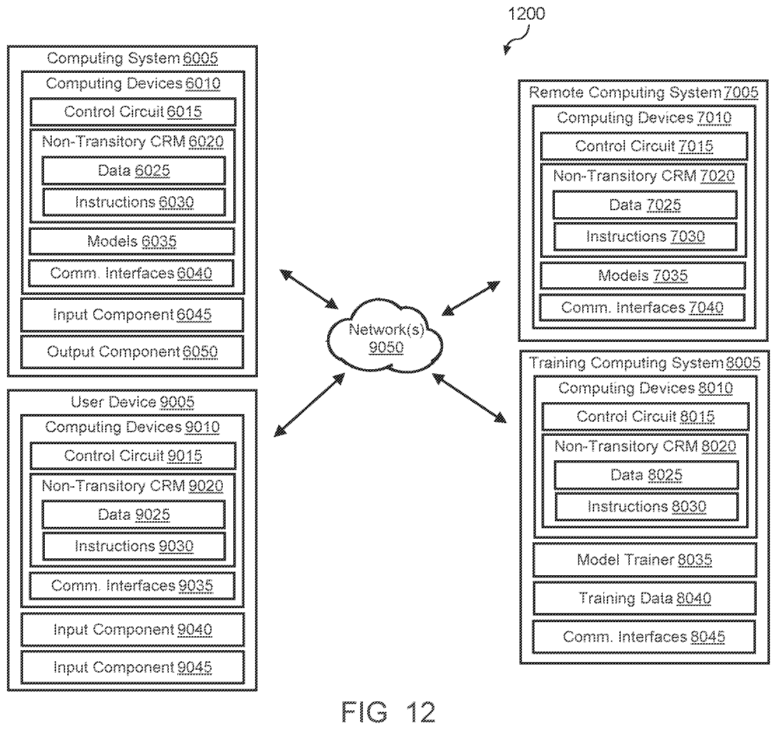

FIG. 12 illustrates a block diagram of an example computing system 1200 according to an embodiment hereof. The system 1200 includes a computing system 6005 (e.g., a computing system onboard a vehicle), a remote computing system 7005 (e.g., a cloud computing system), a user device 9005 (e.g., a AR glasses, a user's mobile phone), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the method of FIG. 11.

In an embodiment, the computing system 6005 may store or include one or more machine-learned models 6035. For example, the machine-learned models 6035 may be or may otherwise include various machine-learned models, including machine-learned generative models (e.g., the AR content generation model). In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to determine a location of a vehicle. For example, the machine-learned models 6035 can, in response to camera sensor data, determine a field of view of a user and determine where a vehicle is and where to display augmented reality graphics to indicate the location of the vehicle.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the method of FIG. 11.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 7050). In some implementations, the communication interfaces 7040 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIG. 11.

The training computing system 8005 may include a model trainer 8035 that trains the machine-learned models 6035, 7035 stored at the computing system 6005 and/or the remote computing system 7005 using various training or learning techniques. For example, the models 6035, 7035 (e.g., an AR content generation model) may be trained using a loss function that evaluates quality of generated samples over various characteristics, such as similarity to the training data.

The training computing system 8005 may modify parameters of the models 6035, 7035 (e.g., the AR content generation model) based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the machine-learned clustering model to modify the parameters (e.g., weights) of the generative model. The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include various types of user devices. This may include wearable devices (e.g., glasses, watches, etc.), handheld devices, tablets, or other types of devices.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIG. 11.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components. As described herein, the output components 9045 may include a form factor such as lens of glasses. This can be used for an AR interface displayed via the user device 9005, while it is worn by a user.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### ADDITIONAL DISCUSSION OF VARIOUS EMBODIMENTS

Embodiment 1 relates to a computer-implemented method. The method can include accessing, by a computing system, data indicative of a location of a vehicle associated with a user. The method can include determining, by the computing system, a user interface element for display associated with the vehicle within an augmented reality environment. The method can include outputting, by the computing system, one or more signals to present, via a display device associated with a user device, content that presents the user interface element associated with the vehicle within the augmented reality environment, wherein the user interface element is visible within the augmented reality environment at the location of the vehicle when at least a portion of the vehicle is within a field of view of the user.
Embodiment 2 includes the method of embodiment 1. In this embodiment, the method can include accessing, by the computing system, data indicative of a location of the user device, wherein the user device is associated with the user. In this embodiment the display device is a display device of a wearable computing system, and the method can include determining, by the computing system and based on the data indicative of the location of the vehicle and the location of the user device, a route to the location of the vehicle. In this embodiment the display device is a display device of a wearable computing system, and the method can include generating, by the computing system and based on the route to the location of the vehicle, navigation content comprising information for navigating the user to the location of the vehicle. In this embodiment the display device is a display device of a wearable computing system, and the method can include outputting, by the computing system, one or more signals to display, via a user interface of the wearable computing system, the navigation content for the user within the augmented reality environment, the navigation content including the information for navigating the user to the location of the vehicle.
Embodiment 3 includes the method of embodiment 2. In this embodiment, determining the route to the location of the vehicle can include determining, by the computing system and based on the location of the vehicle and the location of the user device, a relative location of the vehicle to the user device. In this embodiment, determining the route to the location of the vehicle can include determining, by the computing system, the route to the location of the vehicle based on the relative location of the vehicle to the user device.
Embodiment 4 includes the method of embodiment 2. In this embodiment, determining the user interface element for display associated with the vehicle within the augmented reality environment can include generating a first set of augmented reality graphics based on the field of view of the user and the location of the user. In this embodiment, determining the user interface element for display associated with the vehicle within the augmented reality environment can include generating a second set of augmented reality graphics based on the navigation content and the route to the location of the vehicle.
Embodiment 5 includes the method of embodiment 4. In this embodiment, the second set of augmented reality graphics can include directional steps for moving from the location of the user device to the location of the vehicle based on the navigation content. In this embodiment, the second set of augmented reality graphics can include a pathway, based on the route to the location of the vehicle, indicative of where to move to arrive at the vehicle.
Embodiment 6 includes the method of embodiment 1. In this embodiment the user device may be a wearable computing system, and the display device may be an augmented reality display of the wearable computing system.
Embodiment 7 includes the method of embodiment 1. In this embodiment, the vehicle may be a personal vehicle of the user.
Embodiment 8 includes the method of embodiment 1. In this embodiment, the vehicle may be associated with a transportation service for the user, and the data indicative of the location of the vehicle may be provided via a computing system associated with the transportation service.
Embodiment 9 includes the method of embodiment 1. In this embodiment, the data indicative of the location of the vehicle may be provided by the vehicle when the vehicle is in a parked state.
Embodiment 10 includes the method of embodiment 1. In this embodiment, the computing system may be a remote computing system that may be remote from the user device and the vehicle.
Embodiment 11 includes the method of embodiment 1. In this embodiment, accessing data indicative of the location of the vehicle can include outputting one or more signals to wake-up the vehicle. In this embodiment, accessing data indicative of the location of the vehicle can include, in response to the one or more signals to wake-up the vehicle, receiving, from the vehicle, the data indicative of the location of the vehicle.
Embodiment 12 includes the method of embodiment 1. In this embodiment, the computing system may be a computing system of the user device.
Embodiment 13 includes the method of embodiment 12. In this embodiment, the method can include determining, by the computing system, that the user device is within a communication range of the vehicle.
Embodiment 14 includes the method of claim 1. In this embodiment, the user interface element can include an icon positioned above the location of the vehicle.
Embodiment 15 relates to a computing system of a vehicle. The computing system may include a control circuit. The control circuit may be configured to access data indicative of a location of a vehicle associated with a user. The control circuit may be configured to determine a user interface element for display associated with the vehicle within an augmented reality environment. The control circuit may be configured to output one or more signals to present, via a display device associated with a user device, content that includes the user interface element associated with the vehicle within the augmented reality environment, wherein the user interface element is visible within the augmented reality environment at the location of the vehicle when at least a portion of the vehicle is within a field of view of the user.
Embodiment 16 includes the computing system of embodiment 15. In this embodiment, the display device may be a display device of a wearable computing system, and the control circuit may be further configured to access data indicative of a location of the user device, wherein the user device may be associated with the user. In this embodiment, the display device may be a display device of a wearable computing system, and the control circuit may be further configured to determine, based on the data indicative of the location of the vehicle associated with the user and the location of the user device, a route to the location of the vehicle. In this embodiment, the display device may be a display device of a wearable computing system, and the control circuit may be further configured to generate, based on the route to the location of the vehicle, navigation content comprising information for navigating the user to the location of the vehicle. In this embodiment, the display device may be a display device of a wearable computing system, and the control circuit may be further configured to output one or more signals to display, via a user interface of the wearable computing system, the navigation content for the user within the augmented reality environment, the navigation content including the information for navigating the user to the location of the vehicle.
Embodiment 17 includes the computing system of embodiment 16. In this embodiment, determining the user interface element for display associated with the vehicle within the augmented reality environment can include generating a first set of augmented reality graphics based on the navigation content and the route to the location of the vehicle. In this embodiment, determining the user interface element for display associated with the vehicle within the augmented reality environment can include generating a second set of augmented reality graphics based on the field of view of the user and the location of the user.
Embodiment 18 includes the computing system of embodiment 16. In this embodiment, the user device may be a head-wearable computing system, and wherein the display device may be an augmented reality display of the head-wearable computing system.
Embodiment 19 includes the computing system of embodiment 16. In this embodiment, the vehicle may be a personal vehicle of the user or a vehicle being utilized for providing a transportation service requested by the user via a software application associated with the transportation service, the software application running on the user device.
Embodiment 20 is directed to one or more non-transitory computer-readable media. The one or more non-transitory computer readable media can store instructions that are executable by a control circuit. The control circuit executing the instructions can access data indicative of a location of the user device, wherein the user device is associated with the user. The control circuit executing the instructions can determine, based on the data indicative of the location of the vehicle and the location of the user device, a route to the location of the vehicle. The control circuit executing the instructions can generate, based on the route to the location of the vehicle, navigation content comprising information for navigating the user to the location of the vehicle. The control circuit executing the instructions can output one or more signals to display, via a user interface of the wearable computing system, the navigation content for the user within the augmented reality environment, the navigation content comprising the information for navigating the user to the location of the vehicle.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

Computing tasks and operations discussed herein as being performed at or by computing device(s) remote from the vehicle can instead be performed at the vehicle (e.g., via the vehicle computing system), or vice versa.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computer-implemented method comprising:
accessing, by a computing system, data indicative of a location of a vehicle associated with a user;
determining, by the computing system, a user interface element for display associated with the vehicle within an augmented reality environment; and
outputting, by the computing system, one or more signals to present, via a display device associated with a user device, content that presents the user interface element associated with the vehicle within the augmented reality environment, and
wherein the user interface element is visible within the augmented reality environment at the location of the vehicle when at least a portion of the vehicle is within a field of view of the user.

2. The computer-implemented method of claim 1, wherein the display device is a display device of a wearable computing system, and wherein the method further comprises:
accessing, by the computing system, data indicative of a location of the user device, wherein the user device is associated with the user;
determining, by the computing system and based on the data indicative of the location of the vehicle and the location of the user device, a route to the location of the vehicle;
generating, by the computing system and based on the route to the location of the vehicle, navigation content comprising information for navigating the user to the location of the vehicle; and
outputting, by the computing system, one or more signals to display, via a user interface of the wearable computing system, the navigation content for the user within the augmented reality environment, the navigation content comprising the information for navigating the user to the location of the vehicle.

3. The computer-implemented method of claim 2, wherein determining the route to the location of the vehicle comprises:
determining, by the computing system and based on the location of the vehicle and the location of the user device, a relative location of the vehicle to the user device; and
determining, by the computing system, the route to the location of the vehicle based on the relative location of the vehicle to the user device.

4. The computer-implemented method of claim 2, wherein determining the user interface element for display associated with the vehicle within the augmented reality environment comprises:
generating a first set of augmented reality graphics based on the field of view of the user and the location of the user; and
generating a second set of augmented reality graphics based on the navigation content and the route to the location of the vehicle.

5. The computer-implemented method of claim 4, wherein the second set of augmented reality graphics comprise:
directional steps for moving from the location of the user device to the location of the vehicle based on the navigation content; and
a pathway, based on the route to the location of the vehicle, indicative of where to move to arrive at the vehicle.

6. The computer-implemented method of claim 1, wherein the user device is a wearable computing system, and wherein the display device is an augmented reality display of the wearable computing system.

7. The computer-implemented method of claim 1, wherein the vehicle is a personal vehicle of the user.

8. The computer-implemented method of claim 1, wherein the vehicle is associated with a transportation service for the user, and wherein the data indicative of the location of the vehicle is provided via a computing system associated with the transportation service.

9. The computer-implemented method of claim 1, wherein the data indicative of the location of the vehicle is provided by the vehicle when the vehicle is in a parked state.

10. The computer-implemented method of claim 1, wherein the computing system is a remote computing system that is remote from the user device and the vehicle.

11. The computer-implemented method of claim 1, wherein accessing data indicative of the location of the vehicle comprises:
outputting one or more signals to wake-up the vehicle; and
in response to the one or more signals to wake-up the vehicle, receiving, from the vehicle, the data indicative of the location of the vehicle.

12. The computer-implemented method of claim 1, wherein the computing system is a computing system of the user device.

13. The computer-implemented method of claim 12, further comprising:
determining, by the computing system, that the user device is within a communication range of the vehicle.

14. The computer-implemented method of claim 1, wherein the user interface element comprises an icon positioned above the location of the vehicle.

15. A computing system comprising:
a control circuit configured to:
access data indicative of a location of a vehicle associated with a user;
determine a user interface element for display associated with the vehicle within an augmented reality environment; and
output one or more signals to present, via a display device associated with a user device, content that includes the user interface element associated with the vehicle within the augmented reality environment, and
wherein the user interface element is visible within the augmented reality environment at the location of the vehicle when at least a portion of the vehicle is within a field of view of the user.

16. The computing system of claim 15, wherein the display device is a display device of a wearable computing system, and wherein the control circuit is further configured to:
access data indicative of a location of the user device, wherein the user device is associated with the user;
determine, based on the data indicative of the location of the vehicle associated with the user and the location of the user device, a route to the location of the vehicle;
generate, based on the route to the location of the vehicle, navigation content comprising information for navigating the user to the location of the vehicle; and
output one or more signals to display, via a user interface of the wearable computing system, the navigation content for the user within the augmented reality environment, the navigation content comprising the information for navigating the user to the location of the vehicle.

17. The computing system of claim 16, wherein determining the user interface element for display associated with the vehicle within the augmented reality environment comprises:
generating a first set of augmented reality graphics based on the navigation content and the route to the location of the vehicle; and
generating a second set of augmented reality graphics based on the field of view of the user and the location of the user.

18. The computing system of claim 16, wherein the user device is a head-wearable computing system, and wherein the display device is an augmented reality display of the head-wearable computing system.

19. The computing system of claim 16, wherein the vehicle is a personal vehicle of the user or a vehicle being utilized for providing a transportation service requested by the user via a software application associated with the transportation service, the software application running on the user device.

20. One or more non-transitory computer-readable media that store instructions that are executable by a control circuit to:
access data indicative of a location of the user device, wherein the user device is associated with the user;
determine, based on the data indicative of the location of the vehicle and the location of the user device, a route to the location of the vehicle;
generate, based on the route to the location of the vehicle, navigation content comprising information for navigating the user to the location of the vehicle; and
output one or more signals to display, via a user interface of the wearable computing system, the navigation content for the user within the augmented reality environment, the navigation content comprising the information for navigating the user to the location of the vehicle.
